(19) United States
(12) Patent Application Publication
(10) Pub. No.: US 2017/0368586 A1
(43) Pub. Date: Dec. 28, 2017

(54) APPARATUS AND METHOD FOR PRODUCING STRIP WOUND TUBES

(71) Applicant: WESTFALIA METALLSCHLAUCHTECHNIK GMBH & CO. KG, 57271 Hilchenbach (DE)

(72) Inventors: KARSTEN SCHENK, Schwalmstadt (DE); OLIVER SELTER, Attendorn (DE); MATTHIAS WEISS, Hilchenbach (DE); STEFAN HAUK, Hilchenbach (DE); DIETMAR BAUMHOFF, Olpe (DE); KARL-HEINZ MÜNKER, Hilchenbach (DE); MICHAEL HENKELMANN, Hilchenbach (DE); ANDREAS GERHARD, Wenden (DE)

(73) Assignee: WESTFALIA METALLSCHLAUCHTECHNIK GMBH & CO. KG, 57271 Hilchenbach (DE)

(21) Appl. No.: 15/538,541

(22) PCT Filed: Feb. 22, 2016
(86) PCT No.: PCT/EP2016/053630

§ 371 Date: Jun. 21, 2017

Related U.S. Application Data
(60) Provisional application No. 62/172,626, filed on Jun. 8, 2015.

(30) Foreign Application Priority Data
Mar. 19, 2015 (DE) 10 2015 003 467.7
Sep. 14, 2015 (DE) 10 2015 115 456.0
Oct. 19, 2015 (DE) 10 2015 118 476.1

(51) Int. Cl. B21C 37/12; B23K 26/38; B23K 26/08; F16L 11/16; B23K 26/302

(52) U.S. Cl. CPC B21C 37/122; F16L 11/16; B23K 26/302; B23K 26/0823; B23K 26/38

(57) ABSTRACT

An apparatus and a method for producing strip wound tube products are disclosed. The apparatus includes a winding machine for winding a strip to a strip wound tube and a finishing machine for cutting off pieces of desired length from the strip wound tube and for connecting strip layers in the end sections of the strip wound tube product by way of an joining operation, the finishing machine having a mobile operating head and/or a force decoupling unit.

The invention relates to a device for producing strip wound tube products, a force decoupling unit for such a device, and a corresponding manufacturing method.

Processes are known from the state of the art for producing and finishing conduit elements for exhaust systems of motor vehicles, which are constructed sequentially. In this process, a metal strip is first profiled by rolling and is then formed into a final geometry in a winding process. While the profile passes through the last forming steps it is hooked with the leading profile cross-section. This sequence leads to a continuously produced flexible conduit element, which is referred to as a “strip wound tube”. In a subsequent cut, the strip wound tube is cut to a final end length in order to obtain the desired strip wound tube product.

In this context, the patent DE19851173C1 describes a sequential method and a device for the production of connecting ends on metal tubes, in which a radially continuous circumferential laser seam is produced in sinusoidal or triangular form on strip wound tubes produced in long lengths. In the subsequent step, the strip wound tube is cut to its final length by a radially circumferential separating cut.

Patent EP674964B1 describes similar process steps, wherein a left and a right quilting seam are produced by temporal pulsing of the laser beam and a laser-based separating cut comes to lie in the space between the two quilting seams.

AT220456B describes a two-stage separation process for a strip wound conduit element. In the pre-operation, a V-shaped groove is first introduced on the basis of a weld seam preparation. Subsequently, the actual separating cut is preformed perpendicular to the longitudinal axis of the conduit element. During the two operations, the conduit element rotates. The operating heads have a direction of movement perpendicular to the pipe axis and are moved along in the “flying” assembly synchronously to the feed direction of the conduit element.

In a two-stage separation process according to DE102007018927A1, the profile to be separated does not rotate. Only the operating head moves perpendicularly to the longitudinal axis and is moved along in a “flying” assembly synchronously with the feed direction of the conduit element.

A likewise stationary conduit element is disclosed in EP787553B1, in which several separating units operate around the conduit element, in order to mechanically separate the conduit element.

In DE19851173C1, DE4411246A1 and EP674964B1, combined joining and separating processes for metal hoses are disclosed, in which a radially continuous circumferential laser seam is produced on rotating strip wound tubes produced in long lengths. The laser seam lies in a plane perpendicular to the strip wound tube axis and connects the winding layers to one another. In the subsequent step, a radially circumferential separating cut is produced, which brings the strip wound tube to its final length. The welding and separation technology is hereby primarily based on laser technology.

A similar process is described in U.S. Pat. No. 7,753,083 B2. Here strip wound metal profiles are welded by resistance welding. The tube is then separated in the middle of the weld.

Against this background, it was an object of the present invention to provide means for the improved manufacture of strip wound tube products.

This object is achieved by a device according to claim 1, by a device according to claim 10, by a force decoupling unit according to claim 13, as well as by a method according to claim 14. Advantageous refinements are set forth in the dependent claims.

According to a first aspect, the invention thus relates to a device for the production of strip wound tube products, for example, of sections of strip wound tubes of defined length, which can be used as a conduit element in motor vehicles. In the following, the term “strip wound tube” is to be understood as the essentially endless intermediate product which is produced by winding a strip, while the term “strip wound tube product” refers to a subsequent product produced therefrom by further processing (for example cutting). Typically, as described above, the strip wound tube is produced from a profiled metal strip. The device according to the invention contains the following components:
A winding machine for winding a strip into a strip wound tube.
A finishing machine for separating pieces of predetermined or desired length from said strip wound tube and for connecting strip layers in the end regions of the strip wound tube product by a joining operation, wherein the finishing machine includes a movable operating head.

The strip may, in particular, be a metal strip. The metal strip can already have pre-profiled intermediate geometries when fed to the winding machine. Additionally or alternatively further profiling stages up to the final geometry are generated on the winding machine itself. During the winding process, the resulting strip wound tube is typically constantly rotated about its longitudinal axis and advanced axially or continuously or discontinuously in the direction of this axis.

The sections separated from the strip wound tube in the finishing machine represent the strip wound tube products to be produced, which are generally processed further. Apart from the separation of tube sections and the joining operation, further processing steps can optionally take place in the finishing machine.

The mobility of the operating head of the finishing machine allows a particularly flexible processing of the strip wound tube. This is because the operating head can in this case approach and follow a processing path on the strip wound tube independently of any possible movement of the strip wound tube (for example by axial feed).

The separation of sections from the strip wound tube carried out in the finishing machine can be performed with any suitable separation technology, for example by punching, cutting, shearing, sawing, filing, burning, eroding or electron beam. It is particularly preferred when the separation is carried out with a laser by cutting using laser energy.

The joining operation may include, for example, welding (MIG/MAG, laser, plasma, resistance, or TIG), soldering, gluing or forming (such as riveting, flanging, stretching or pulling). In particular, strip windings can be welded, for example by means of laser energy. Such welding can take place, in particular, in the region of the separating seam of the severed hose section.

According to a preferred embodiment of the invention, the separation can be effected by cutting by means of laser energy and the joining operation by welding by means of laser energy.

In the aforementioned case, the device according to the invention preferably contains two different optics for laser welding on the one hand, and laser cutting on the other hand. This makes it possible to carry out the two different processes, with respective optimal settings of the laser beam (diameter, focus, etc.).

The aforementioned two optics can each contain a separate laser source. However, it is particularly preferred when the device according to the invention contains a laser source and an integrated beam deflector. This allows taking advantage of different optics with minimal constructional effort, in particular with a single laser source, in that the beam deflector provides the respective optics with laser energy, depending on the processing step.

The above-mentioned optics, the laser source and/or the beam deflector can in particular be components of the finishing machine. Furthermore, in particular, the beam deflector and/or the optics can be arranged wholly or partly on the operating head of the finishing machine.

The operating head of the finishing machine can be movable in at least one translatory direction and/or in at least one rotational direction. Preferably, the operating head is movable or driven in at least two degrees of freedom, for example in
at least two translatory directions and/or
in at least one translatory and at least one rotational direction.

The translatory direction generally includes a component in the direction of the axis of the conduit element to be produced and/or a component in a direction that is radial with respect to the direction of the axis of the conduit element. The rotational direction generally includes a rotation about this axis.

The device is also preferably adapted to carry out the movement of the operating head in an axially synchronized manner with the strip wound tube. In particular, the operating head can be moved along synchronously with the axial feed of the strip wound tube (which axial feed results from its continuous winding).

In addition or alternatively, the device can optionally be configured to change the winding speed of the strip in the winding machine when sections are cut off from the strip wound tube and/or when strip layers are joined in the end regions of the strip wound tube product in the finishing machine. In particular, the winding speed can be reduced while pieces are separated and/or strip layers are connected. This ensures that the separation or joining are performed with a speed that is optimal therefore, while at other times a highest possible process speed is achieved.

Strip wound tubes can be produced both with round (circular) and non-round cross-sections (see DE 10 2012 013946 A1). In this respect the mobility of the operating head has the advantage that even in the case of non-circular cross-sections, the operating head always remains positioned on the outer wall of the strip wound tube where it can perform processing. In particular, the operating head can be mounted so as to be movable in the radial direction so that the operating head can follow the varying distances of the outer surface of the strip wound tube to the hose axis.

According to a preferred embodiment of the device, the device may include two or more movable operating heads. These operating heads can in particular be arranged circumferentially about the axis of the produced strip wound tube, wherein the angle between adjacent operating heads is preferably greater than 5°, greater than approximately 45°, greater than about 90°, greater than about 135°, or greater than about 175°. During a relative rotation between the strip wound tube and the operating heads, the processes associated with the operating heads can then be executed sequentially on the outer surface of the strip wound tube.

The at least one operating head of the finishing machine can optionally have at least one universal module carrier. This means that depending of the application this module carrier can be equipped with modules (tools) of different production technologies. Such applications may include any mechanical, thermal, electrical and chemical processes which belong to the six main groups of production technology according to DIN 8580.

Several modular carriers can optionally be arranged side by side in axial direction and/or in the tangential direction (with respect to the strip wound tube to be produced) and can thus be used successively depending on the movement of the strip wound tube or its end region.

According to a second aspect, the invention relates to a device for the manufacture of strip wound tube products having the following components:
A winding machine for winding a strip into a strip wound tube.
A finishing machine for separating sections of predetermined or desired length from the strip wound tube.
A force decoupling unit which, according to the definition, serves to absorb forces from the strip wound tube, whereby these forces can be introduced into the strip wound tube by the winding machine and/or by the finishing machine.

The device according to the second aspect may optionally also have the features of the device according to the first aspect, i.e., the finishing machine can also be configured for connecting strip layers in the end regions of the strip wound tube product by a joining operation and can include a movable operating head. All statements and explanations regarding the device according to the first aspect therefore also apply analogously to the device according to the second aspect, and vice versa.

By means of the force decoupling unit, forces which are exerted by the winding machine or by the finishing machine on the strip wound tube and are then transmitted by the strip wound tube along its axis, can be absorbed completely or at least partially. The transmission of such forces along the strip wound tube is suppressed at least partially, so that any disturbances potentially caused by the forces in other processing stations can be prevented or at least minimized. The force decoupling unit preferably takes up more than 50%, more than 80%, and particularly preferably approximately 100%, of the force introduced into the strip wound tube.

The force decoupling unit usually has a more or less large, locally limited active zone, within which it co-operates with the strip wound tube for absorbing the forces. In principle, this active zone can be located at any desired or suitable position of the strip wound tube. The effective zone is preferably located in a region along the extent of a produced strip wound tube between the winding machine and the finishing machine. In this way it is possible during the operation of the device to prevent forces exerted by the winding machine from acting into the finishing machine where they may cause process disturbances, and in the opposite direction to prevent the effects of forces acting from the finishing machine into the winding machine.

The force decoupling unit can in particular be an independent device which can be used and set up independently of the winding machine and the finishing machine. However, the force decoupling unit can also be structurally and/or functionally coupled to the winding machine and/or to the finishing machine if this proves to be advantageous. With such a coupling, it must be noted that forces absorbed by the force decoupling unit are transmitted to the corresponding carrier machine.

The force decoupling unit can generally absorb forces in various ways, for example without contact via magnetic fields or via pneumatically damped buffers. In particular, however, at least one contact element may be provided in the force decoupling unit which is in force-fitting and/or form-fitting contact and/or in frictional contact with the strip wound tube when a strip wound tube is located in the device during operation (the latter condition is always implicitly assumed below, when the strip wound tube is mentioned). A form-fitting contact can, for example, be effected by a coupling to the (e.g. cylindrical) outer surface of the strip wound tube in order to fix the latter in the radial direction by means of a form-fit. In particular, a form fit can also take place in the axial direction in order to be able to fix the tube in the axial direction or to absorb corresponding forces. Such a form-fit may for example involve engagement in depressions along the windings of the strip wound tube.

In order to avoid a one-sided force effect on the strip wound tube, two or more of the aforementioned contact elements can be arranged circumferentially distributed around the strip wound tube. For symmetry reasons, an equidistant distribution of the contact elements is preferred. For example, three contact elements can be arranged at a sequential angular distance of 120 degrees, four contact elements at an angular distance of 90 degrees, five contact elements at an angular distance of 72 degrees, six contact elements at an angular distance of 60 degrees and generally n contact elements at an angular distance of 360°/n. It is also possible for the contact element to surround the strip wound tube in a ring-shaped manner continuously.

The at least one contact element is preferably freely positionable in at least one direction. Additionally or alternatively, it can be arranged movably in at least one direction, in particular movably against a restoring force urging the contact element into a rest position. In this way, the force decoupling unit can be provided with a certain flexibility, by means of which tolerances and process fluctuations can be compensated.

The at least one contact element can optionally be in frictional contact with the strip wound tube. In this case the contact element can in particular be configured so that a movement of the strip wound tube relative to the element (in the axial direction and/or tangential direction of the strip wound tube) causes a friction force that inhibits the movement. In this way, the transmission of forces, which are associated with a visible (macroscopic) movement of the strip wound tube, can be damped or suppressed.

According to another embodiment, the contact element can have a shaping roller, which engages in a winding of the strip wound tube. In this case, a form-fitting coupling between the intermediate contact element and the strip wound tube can be produced by means of which also statically transmitted forces (in which the strip wound tube behaves as a rigid body) can be absorbed. The shaping roller can in particular be rotatably mounted, so that certain movements of the strip wound tube relative to the roller are possible with low friction or unimpeded, in particular rotations of the strip wound tube about its longitudinal axis.

During the operation of the device, strip material is generally continuously strip wound into a strip wound tube, from which strip wound tube products are (discontinuously) cut. In such a flow process, the resulting strip wound tube is typically transported past the processing stations. For this purpose, the winding machine and/or the finishing machine and/or the force decoupling unit preferably has a device for moving the strip wound tube in the direction of the tube axis and/or for rotation of the strip wound tube about the tube axis.

The force decoupling unit is typically a structurally separate device (separate from the winding machine and the finishing machine and optionally connectable to one of these machines), which is independently operable/functional. The invention thus also relates to a force-decoupling unit for a device of the aforementioned type. This means that with such a force decoupling unit forces can be absorbed from a strip wound tube which were introduced into the strip wound tube at a different location, for example by a winding machine or a finishing machine.

According to a further aspect, the invention relates to a method for producing strip wound tube products, comprising the following steps:
Winding a strip into a strip wound tube.
Separating sections from the strip wound tube.
Absorbing forces from the strip wound tube, which were introduced into the strip wound tube during the winding and/or during the separation.

The method can in particular be carried out with a device or force decoupling unit of the type described above. Explanations and modifications given above for the device or unit, therefore also apply analogously to the method, without being explained in detail again.

The invention is explained in more detail below by way of example by means of the figures. Herein:

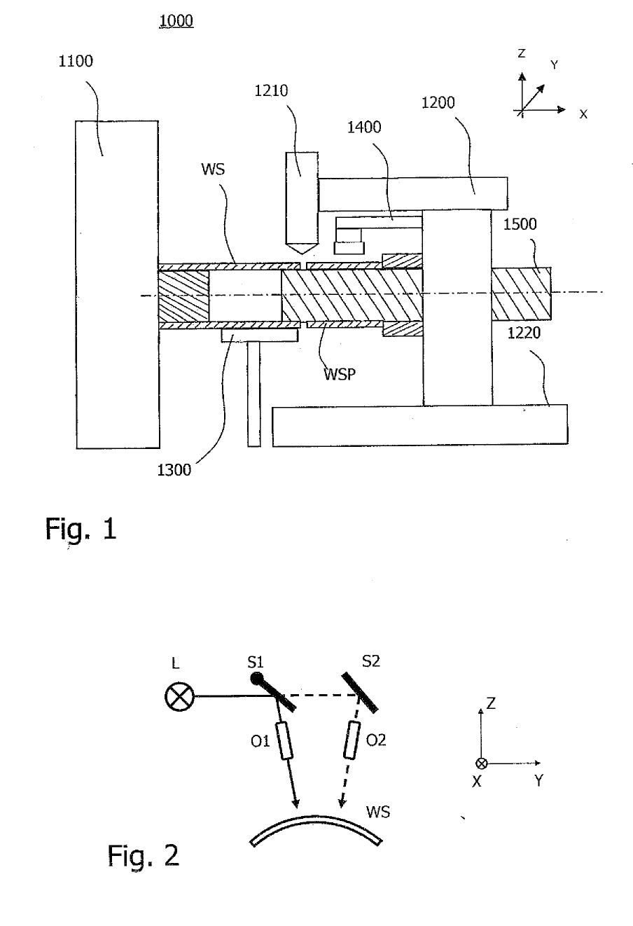

FIG. 1 is a schematic side view of a first device for manufacturing of wrap hose products;

FIG. 2 schematically shows the arrangement of a laser source and a beam switch of the device of FIG. 1;

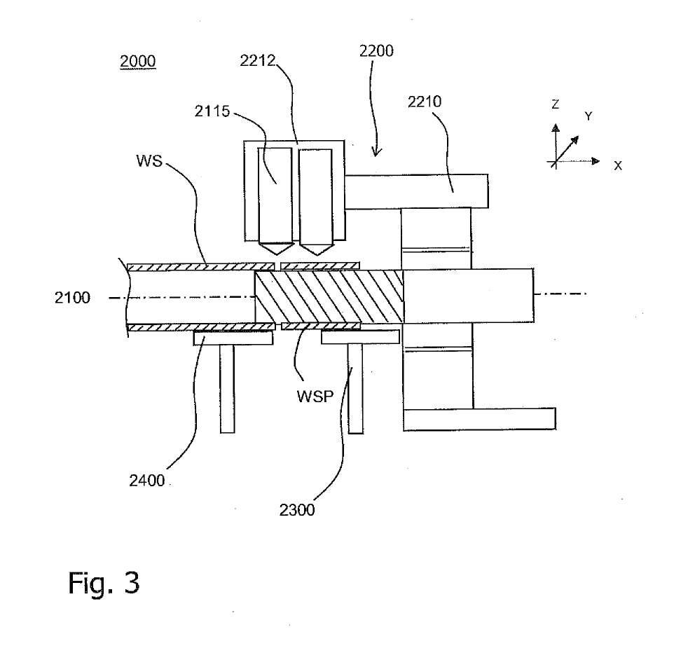

FIG. 3 is a schematic side view of a second device for manufacturing of strip wound tube products comprising a plurality of module carriers;

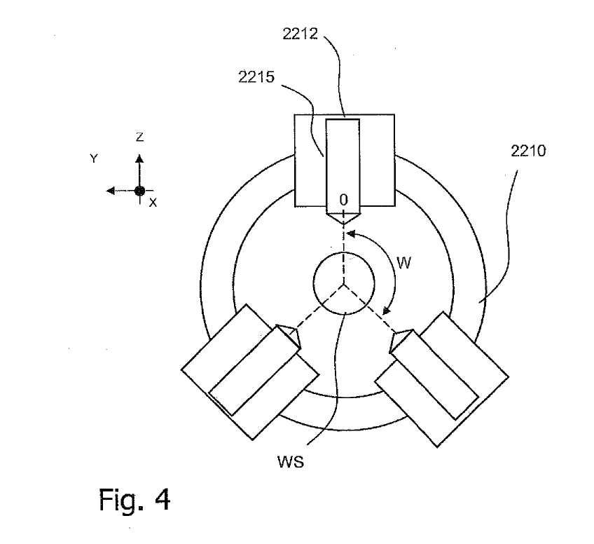

FIG. 4 is a plan view of the operating head of the device of FIG. 3;

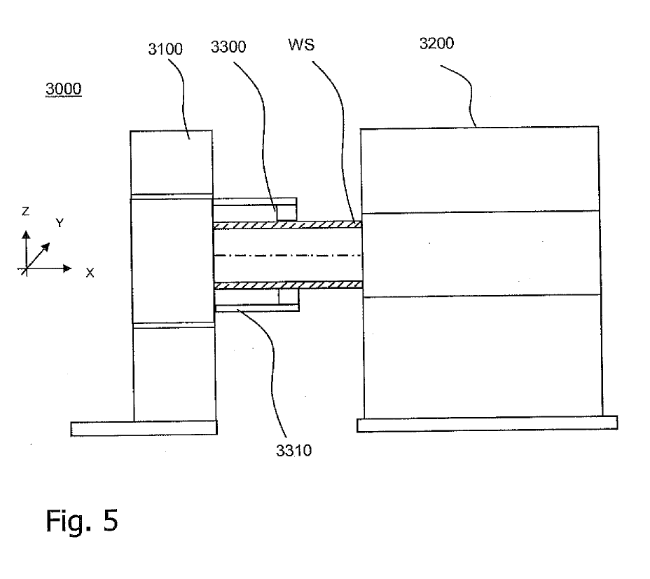

FIG. 5 is a schematic side view of a third apparatus for manufacturing of strip wound tube products comprising a force decoupling unit;

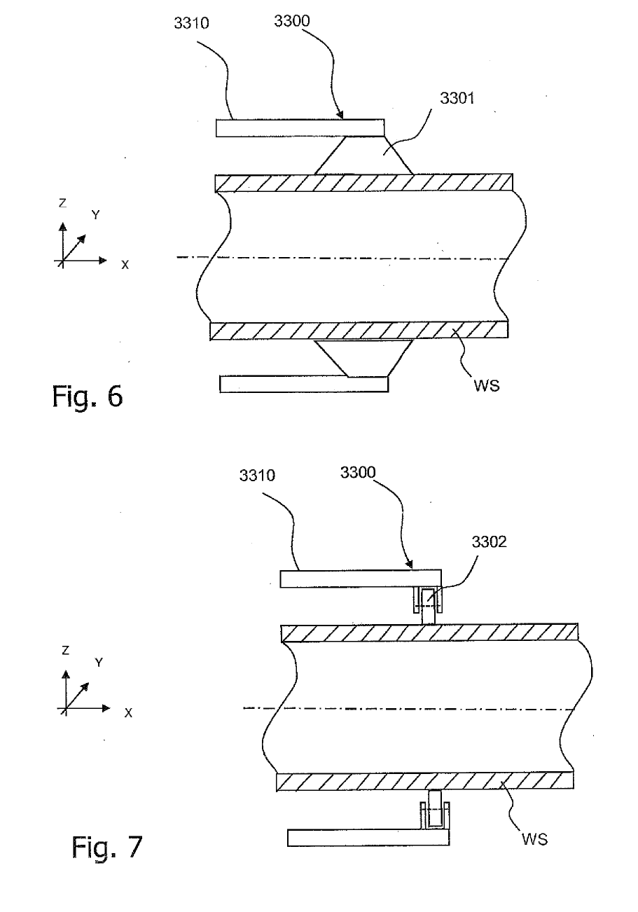

FIG. 6 shows an embodiment of the force decoupling unit with friction elements;

FIG. 7 shows an embodiment of the force decoupling unit with shaping rollers.

In the Figures, identical or comparable components of different embodiments are designated with reference numerals that differ by multiples of 1000.

FIG. 1 shows a schematic side view of a first embodiment of a device 1000 according to the present invention. The device is used for the manufacture of strip wound tube products WSP and comprises the following components:
A winding machine 1100 (also referred to as a “forming unit”) in which a supplied (metal) strip (not shown) is wound into a strip wound tube WS. The strip wound tube WS produced in this way exits the winding machine continuously in X-direction (in FIG. 1 towards the right), whereby the strip wound tube rotates about the tube axis (X-axis) and at the same time moves in this axial direction.
A finishing machine 1200 (also referred to as a “cutting-separating unit”), in which the produced strip wound tube WS is processed. The processing can in this case particularly include the separation of tube sections of desired length. Typically, in the finishing machine, windings are also bonded (e.g. welded) together to prevent subsequent opening of the tube. The separated and optionally connected or welded tube pieces represent the strip wound tube products WSP to be produced with the device. These can be used, for example, in decoupling elements for decoupling vibrations in exhaust systems of motor vehicles.

The shown device 1000 optionally further includes transport devices 1400, holding devices 1300, and/or a suction lance 1500. With the device 1000, a complete system is provided which does not include circulating stock and which produces a strip wound tube from slit strip which directly obtains its final end length and its final end state. The two process steps “production of the strip wound tube in long lengths” and “cutting to final length” are integrated and synchronized so that the finished separated strip wound tubes are continuously formed without interrupting the winding process.

In a typical implementation, the winding machine 1100 or forming unit includes a rolling device for the slit strip, a roller profiling unit and the tools, devices and drives required for the core process.

In the roll profiling process an intermediate geometry is formed in the profile cross section from the flat strip, which intermediate geometry is further shaped into the final geometry in the downstream winding process. Hereby the leading winding of the strip wound tube is hooked in with the winding coming from the profiling. In this continuous process, a strip wound tube WS is formed whose axial extent gradually increases as the process proceeds, which is preferably supported by holding devices 1300 in such a way that the flexible tube retains its frictional properties and is not affected by gravity, i.e., it maintains its straight shape.

The finishing machine 1200 or cutting/separating unit comprises an operating head 1210, which can be moved at least in one axis and is mounted on a positioning unit 1220 aligned in the axial direction of the strip wound tube WS (X-axis). The special feature of the device 1000 is that when the strip wound tube WS reaches a position that is favorable for the operating head 1210, the strip wound tube is subjected to an axial synchronization. This synchronization ensures an absolute positioning of the operating head 1210 relative to the still continuously rotating and growing strip wound tube WS. This is followed by a combined welding-cutting-separating operation, in which a final prefabricated strip wound tube product WSP is generated, which is connected in final length with connected strip edges.

A suction lance 1500, which is positioned relative to the finishing machine 1200, ensures the removal of dust and particles and thus contributes to the necessary cleanliness within the strip wound tube.

With the aid of a transport device 1400, the final finished strip wound tube product WSP is removed without interrupting the forming process. After the removal, the finishing machine 1200 is again positioned relative to the emerging strip wound tube WS and the same process starts again.

The arrangement described above enables an ongoing, continuous assembly and provision of a strip wound tube which is cut to final length without interrupting the production process.

An embodiment of the operating head 1210 is a combined welding-cutting-separating device. In addition to a combined unit, a preferred embodiment provides for two separate units, which perform the welding and cutting tasks separately. The welding operation, the cutting operation and/or the separation operation can be based on mechanical as well as thermal methods.

The winding speed (measured for example in revolutions per minute), with which the strip wound tube WS is produced in the winding machine 1100, should be as high as possible to maximize the production rate, wherein normally boundary conditions have to be taken into account depending on the type of the strip being processed and the properties of the desired product. Furthermore, the winding speed can preferably be changed, while joining operations and/or separation operations are performed on the strip wound tube WS. In particular, during these times the winding speed can be reduced so that these subprocesses can be performed at a speed suitable for these subprocesses. The energy applied for a welding or a separating cut has for example to act for a certain minimum time on the strip material, resulting in upper limits for the feed-through speed.

A preferred embodiment is a laser-based welding and cutting of the strip wound tube WS. Practical experience shows that a stable laser welding and subsequent laser cutting can be reliably realized with two different optics. Since welding and cutting are performed sequentially, an integrated beam deflector is advantageous so that the laser energy can be provided by a single laser source.

FIG. 2 schematically shows the arrangement of a laser source L and a beam deflector S1 in the device 1000 of FIG. 1. In the shown first setting of the beam deflector S1 a laser beam emitted from the laser source L is guided into a first optical system O1 (for example an optics that is optimized for the welding) and from the first optical system is further guided onto the outer surface of the strip wound tube WS (solid-line beam path). In contrast, in a second setting of the beam deflector S1 (travel shutter of the illustrated mirror) the laser beam reaches a mirror S2, from which it is guided into a second optical system O2 (for example an optical system optimized for cutting) and from this second optical system is guided onto the outer surface of the strip wound tube WS (beam path shown in dashed lines). At least some of the illustrated components (laser source L, beam deflector S1, mirror S2, optical systems O1 and O2) can be arranged wholly or partly in the finishing machine 1200 or in the operating head 1210.

Further advantageous or optional features of the device 1000 may be:
A multi-parameter synchronization between the winding machine 1100 and the finishing machine 1200.
A multi-parameter synchronization between the operating head 1210 of the finishing machine 1200 and the suction lance 1500.
The rotation of the strip wound tube WS in the winding machine 1100 forms the kinematic basis for the production of a radially circumferential weld seam and/or a radially circumferential separating cut.
The strip wound tube products can be removed from the plant without stopping the forming process.
In a synchronized, uninterrupted process, a strip wound tube, which is cut to a defined length, is produced from a flat metal strip, in which strip wound tube the tape layers are connected to one another in the end regions by a joining operation.
In the case of welding and/or cutting operations, the focus position on the tube surface is controlled online with a multi-parameter distance sensor system and is synchronized with the entire forming process.

FIG. 3 schematically shows a second embodiment of a device 2000 according to the invention for the production of strip wound tube products WSP. Components which are identical or similar to those of the device 1000 of FIG. 1 are designated with reference signs that are increased by 1000 with respect to the device of FIG. 1, and will not be explained in detail again.

The apparatus 2000 includes:

A winding machine 2100 (not further shown) in which a section of a conduit element WS is produced by continuously winding a profiled strip. The profiled strip is advanced via an optional transport device 2400 in the direction of the X-axis (tube axis, in the Figure towards the right).
A finishing machine 2200 for the separation of strip wound tube products WSP from the conduit element WS.
An operating head 2210 movable or driven in at least two degrees of freedom.
At least one processor head 2212 belonging to the operating head 2210 with at least one module carrier 2115 for receiving production technology units.
Optionally at least one holding device 2300 for the conduit element WS to be processed and/or for its end region WSP.

The conduit element is preferably a strip wound conduit element (for example a strip wound tube WS made from a profiled metal strip). Typically, the conduit element is produced by winding in the same process in which processing is also carried out by the processing method or the processing device shown in detail in FIG. 3. The processing method or the processing device generally operate in an end region of the conduit element produced by winding in a larger length, wherein the end region includes approximately the length of a ready-to-use conduit element. Thus typically a section of the conduit element is continuously strip wound and in the same process a desired length is separated therefrom in an end region. Furthermore, a joining operation, in which, for example, windings of the strip wound strip are joined (for example, by welding), is optionally performed in parallel to the winding process (and in parallel to the separating process which takes place in an interval-like manner). The separation and the joining are carried out in the device 2000 preferably on at least one combination module on a processor head 2212 of the operating head 2210 or on at least two modules 2115 on one or different processor heads of the operating head.

The operating head 2210, which is driven in a plurality of degrees of freedom, and is arranged in the end region WSP of the strip wound tube, produces translatory movements (preferably in the X direction, but optionally also in the Y and/or Z direction) as well as rotary movements (preferably in the Y, Z plane about the X-axis) of the processor head 2212 and can realize up to 6 degrees of freedom depending on the application. Even in the case of non-circular cross-sections of the conduit element WS, the processor head (due to movement in the radial Z-direction) can always be positioned on the outer wall of the conduit element WS where it can perform a processing operation.

The controlled axis which grows in X-direction with the end of the conduit element hereby has an important function. This axis serves to synchronize the production operation in the longitudinal direction (X-direction) of the conduit element WS. The operating head 2210 carries at least one processor head 2212, in which one or more module carriers 2115 accommodate the production technologies for the respective application. The module carriers can optionally be arranged adjacent each other in the axial direction (X-direction) and/or in the tangential direction (Y-direction) and thus, depending on the movement of the conduit element WS or the end region WSP, can be used sequentially.

The processes that can be used in the module carriers 2115 include all mechanical, thermal, electrical and chemical processes which belong to the six main groups of production technology according to DIN 8580. In an advantageous embodiment, the separation technology includes but is not limited to:
Cutting by punching, cutting, shearing, sawing, filing
Separating by burning
Separating by eroding, electron beam or laser.

In the filed of joining technology, non-detachable connections include but are limited to:
Joining by welding with MIG/MAG, laser, plasma, resistor, TIG
Joining by soldering
Joining by gluing
Joining by forming such as riveting, flanging, stretching or pulling through.

Due to the presence of the variable module carriers 2115, mono-disciplinary as well as multi-disciplinary technology arrangements and combinations can be realized.

Transport devices 2400 for the processed conduit element WS and/or holding devices 2300 for its end region WSP optionally support the above-mentioned production operations.

The arrangement described above makes it possible to process conduit elements in one or more production steps independently of one another in a continuous manner, but also discontinuously, regardless of the cross-section, wherein one or more manufacturing technologies can be used depending on the production task at hand. In particular, a module carrier 2115 can have a welding unit for connecting the windings of the strip wound strip, and another (subordinated) module carrier can effect the separation of a finished piece of the conduit element.

An optional embodiment of the operating head 2210 is shown in FIG. 4. In addition to a processor head 2212 which is perpendicular to the longitudinal axis of the conduit element WS, the operating head 2210 can carry further modular processor heads which are preferably arranged at an angle W of 180°, 120° or 90° relative to each other. Each modular processor head 2212 includes at least one module carrier 2215 to accommodate manufacturing technology units. An advantageous embodiment includes a separating head and a welding head.

Further advantageous or optional features of the device 2000 may be:

The operating head 2210 has a parameter-controlled axis for synchronization with the transitorily moving conduit element WS and/or end region WSP of the conduit element.

The conduit element WS is stationary or rotates at least in phases during processing, wherein the conduit element and/or the end region of the conduit element also preferably moves transitorily during the rotation (for example, by forward feed in the direction of the X-axis).

The operating head 2210 has at least one processor head 2212 with at least one universal module carrier 2215. As an alternative, units of different manufacturing technologies may be mounted on such a module carrier, e.g. a welding unit or a cutting unit.

Adjacent processor heads 2212 are arranged at an angle of approximately 5°, approximately 45°, approximately 90°, approximately 135°, approximately 175°. Rotation of the conduit element or its end region about its own axis the results in a temporal serial processing by the various processor heads.

A processor head includes two, three, or four module carriers 2215 for installing technology units, e.g. of separating or joining technologies.

The conduit element is stationary at least in phases during the further processing process, or it rotates at least in phases during the further processing process, wherein the conduit element and/or the end region of the conduit element preferably also moves transitorily.

In summary the exemplary embodiment of FIGS. 3 and 4 thus relates to a processing method and a processing device for conduit elements, wherein an operating head is driven in a number of translatory and/or rotational directions of movement and has a synchronization with the feed direction of the conduit element as a “flying” assembly. The operating head has at least one processor head with at least one universal module carrier for carrying technology units. This provides a processing method which is independent of the geometry of the conduit element and in which different technologies can be used.

FIG. 5 shows a third embodiment of a device 3000. Components which are identical or similar to those of the device 1000 of FIG. 1 or the device 2000 of FIG. 3 are designated with reference numerals which compared to the components of FIG. 1 and FIG. 3 are incremented by 2000 or 1000 respectively and are not explained in detail again.

The device 3000 serves for producing strip wound tube products WSP and includes the following components:

A winding machine 3100, in which a supplied (metal) strip is strip wound into a strip wound tube WS.

A finishing machine 3200 in which the produced strip wound tube WS is processed. The processing can hereby particularly include the separation of tube pieces of desired length. Typically, in the finishing machine, a joining (for example, welding) of strip windings takes place in order to prevent a subsequent opening of the tube.

A force decoupling unit 3300, which in the illustrated example is attached to the winding machine 3100 by supports 3310 and is located in the region of the strip wound tube between the winding machine 3100 and the finishing machine 3200.

The force decoupling unit interacts with the strip wound tube WS in an effective zone in so as to absorb forces from the strip wound tube, which were introduced into the tube by the winding machine and/or by the finishing machine. The transmission of such forces is therefore completely or at least partially prevented. This allows preventing or reducing the processing processes in the winding machine on the one hand or the finishing machine on the other hand from disturbing each other. The decoupling of the machines achieved in this manner is particularly advantageous in the case of very loose, flexible strip wound tubes (in which the work required for stretching is almost zero Joules).

The force decoupling unit 3300 can absorb forces from the strip wound tube WS in various ways. In this respect FIG. 6 shows a first option in which contact elements in the form of friction elements 3301 come into frictional contact with the outer surface of the strip wound tube WS. Depending on the configuration of the friction elements, all movements of the strip wound tube relative to the friction element can be uniformly damped or preferably certain movements, for example, in the axial direction, can be damped more strongly than in other directions (e.g. tangential movements).

FIG. 7 shows an alternative embodiment, in which the force decoupling unit 3300 contains forming rollers 3302. Although not shown in detail in the Figure, the forming rollers 3302 (for example, with a pointed-feed roller surface) can engage in recesses along the windings of the strip wound tube WS and thus provide a form-fit (in the axial direction). Preferably, the forming rollers 3302 are rotatably supported so as to virtually not hinder rotation of the tube WS (when the rotation axis of the rollers is parallel to the tube axis or perpendicular to the line of the windings).

While the Figures show force decoupling units 3300 with two diametrically opposite contact elements 3301, 3302 for illustrating reasons, different numbers and arrangements of contact elements can optionally also be provided. In particular, contact elements can be distributed equidistantly about the circumference of the strip wound tube or surround the tube completely in a ring-shaped manner. Furthermore, the contact elements 3301, 3302 of FIGS. 6 and 7 can, of course, also be arranged combined in the same force decoupling unit 3300.

The force decoupling unit is preferably positionable in at least one of the directions X, Y and/or Z, for example by electrical, hydraulic and/or pneumatic positioning elements. Furthermore, the force decoupling unit 3300 or its contact elements 3301, 3302 can be elastically mounted so as to be able to perform certain deflection movements in response to restoring forces.

### LIST OF REFERENCE SIGNS

1000, 2000, 3000 device for production of strip wound tube-products
1100, 2100, 3100 winding machine
1200, 2200, 3200 finishing machine
1210, 2210 operating head
2212 processor head
2215 module carrier
1220 positioning unit
1300, 2300, 3300 holding device, force decoupling unit
3310 supports
3301, 3302 contact elements
1400, 2400 transport devices
1500 suction lancet
L laser light source
S1 beam deflector
S2 mirror
O1, O2 optical systems
WS strip wound tube
WSP strip wound tube-product
W angle

1.-30. (canceled)

31. A device for producing strip wound tube products, comprising:
a winding machine for winding a strip into a strip wound tube; and
a finishing device having a movable operating head, said finishing device being configured for separating sections of the strip wound tube and for joining strip layers in end regions of the strip wound tube product by a joining operation,
said device being configured to perform the movement of the operating head axially synchronized with the strip wound tube.

32. The device of claim 31, wherein the finishing device is configured to perform said separating by cutting with laser energy and to perform the joining operation by welding with laser energy.

33. The device of claim 32, further comprising two different optical systems for the laser welding and the laser cutting.

34. The device of claim 32, further comprising a laser source for said laser energy and an integrated beam deflector.

35. The device of claim 31, wherein the operating head is movable in at least one translatory direction and/or in at least one rotary direction.

36. The device of claim 31, said device being configured to move the operating head axially synchronized with the strip wound tube.

37. The device of claim 31, said device being configured to change, in particular decrease, a winding speed of the strip during the separating of sections from the strip wound tube and/or during a joining of strip layers in the end regions of the strip wound tube products.

38. The device of claim 31, said device being configured to always position the operating head on an outer wall of the strip wound tube and to process the strip wound tube on the outer wall regardless of whether the strip wound tube has a circular or non circular cross section.

39. The device of claim 31, further comprising multiple operating heads, wherein an angle between adjacent ones of the operating heads is greater than 5°, greater than 45°, greater than 90°, greater than 135°, or greater than 175°.

40. The device of claim 31, wherein the operating head has at least one universal module carrier.

41. A device for producing strip wound tube products, comprising:
a winding machine for winding a strip into a strip wound tube;
a finishing device for separating sections of the strip wound tube; and
a force decoupling unit for absorbing forces from the strip wound tube, which are introduced into the strip wound tube by the winding machine and/or by the finishing device, said force decoupling unit having at least one contact element in force fitting contact and/or from fitting contact and/or friction contact with the strip wound tube.

42. The device of claim 41, wherein the force decoupling unit has at least one contact element, which is in force fitting contact and/or friction contact with the strip wound tube.

43. The device of claim 41, further comprising at least two of said contact elements arranged circumferentially distributed about the strip wound tube.

44. A force decoupling unit configured for absorbing forces from a strip wound tube, which are introduced into the strip wound tube by a winding machine for winding a strip into a strip wound tube and/or by a finishing device for finishing the strip wound tube.
